(19) United States
(12) Patent Application Publication
(10) Pub. No.: US 2009/0208183 A1
(43) Pub. Date: Aug. 20, 2009

(54) METHOD AND APPARATUS FOR GENERATING MEDIA CLOCK AND RECORDING MEDIUM STORING THE METHOD

(75) Inventors: Man-seok KANG, Suwon-si (KR); Hyun-kwon Chung, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/251,581

(22) Filed: Oct. 15, 2008

(30) Foreign Application Priority Data
Feb. 20, 2008 (KR) 2008-15449

(51) Int. Cl. H04N 5/91

(52) U.S. Cl. 386/66; 386/95; 386/E05.001

(57) ABSTRACT

A method of generating a media clock indicating a time referred to by an application, which is a reference time used during operation of the application so as to synchronize video and the application. The method includes confirming a presentation start time of an enhanced video object unit (EVOBU) corresponding to a system time clock (STC) of playback video, subsequently setting an accumulated playback time of an EVOBU preceding the EVOBU corresponding to the STC as a media clock start time and setting the media clock of the playback video by adding the media clock start time to a difference value obtained by subtracting the presentation start time from the STC.

### CROSS-REFERENCE TO RELATED PATENT APPLICATION

This application claims the benefit of Korean Patent Application No. 2008-15449, filed on Feb. 20, 2008, in the Korean Intellectual Property Office, the disclosure of which is incorporated herein in its entirety by reference.

### BACKGROUND OF THE INVENTION

1. Field of the Invention

Aspects of the present invention relate to a method and apparatus for generating a media clock and a recording medium storing the method, and more particularly, to a method and apparatus for generating a media clock with regard to a new calculation method used to synchronize the media clock and an audio/video (AV) playback time in order to reproduce AV content and operate an interactive application, and a recording medium storing the method.

2. Description of the Related Art

FIG. 1 is a block diagram of a conventional playback apparatus 100. Referring to FIG. 1, a recording medium 110 can be any type of medium, for example, a High-Definition Digital Versatile Disc (HD-DVD) or Blu-ray Disc (BD).

The playback apparatus 100 comprises a data reading unit 120 that reads an AV stream recorded onto the recording medium 110 and a playback unit that reproduces the read AV stream. The playback unit comprises a de-multiplexer 130, a system time clock unit 140, and decoders 150 through 180. The de-multiplexer 130 separates the read AV stream into a video stream, an audio stream, and a sub-picture stream, and transfers the above three streams to a video decoder 150, an audio decoder 160, and a sub-picture decoder 170 or a highlight information (HLI) decoder 180, respectively. A time of outputting the video/audio/sub-picture data or highlight graphic data decoded by the above three decoders 150, 160, and 170 or 180 to an output device such as a display device or a speaker is determined, based on presentation time stamp (PTS) information of each piece of data and a system time clock 140 of the playback apparatus 100.

Since an advanced HD-DVD or BD executes an interactive application produced in accordance with a media clock that is designated by a content producer and is independent of the playback of AV content, an interactive application that is to be synchronized with video by determining a time of a specific application operation will not be in synchronization when based on a conventional system time clock. An inconsistency of the media clock and video is shown in FIG. 2 which illustrates a conventional problem. In this regard, the media clock is a time referred to by the interactive application, which is a reference time used during operation of the interactive application so as to synchronize video and the interactive application.

FIG. 3 is a block diagram of an advanced HD-DVD. Referring to FIG. 3, the advanced HD-DVD comprises a playlist including playback information of all titles included in a disc, titles including a time map (TMAP) used to reproduce the disc, Manifest, and other information. A TMAP includes a start location for each enhanced video object (EVOBU) unit and a timetable containing a playback time of each EVOBU that is calculated in units of frames, based on a television system setting value found in a primary enhanced video object (P-EVOB). The TMAP further includes information on the P-EVOB that is to be reproduced in association with video title set information (VTSI). The Manifest includes information on a markup file and a javascript file that are to be used to execute an application.

The TMAP and a TMAP based application use a media clock in the format of ‘hh:mm:ss:ff’ based on 60 fps or 50 fps according to a type of an output of either 60 Hz or 50 Hz. In this regard, ‘hh’ denotes an hour, ‘mm’ denotes a minute, ‘ss’ denotes a second, and ‘ff’ denotes a frame. However, video data recorded onto the P-EVOB is based on either 29.97 fps or 24 fps, which slightly differs from the timing of the output. The slight difference increases in congruence with a video playback time increasing such that the playback of video for a long time causes a difference of more than several seconds, thereby generating a temporal inconsistency between the application and video. Referring to FIG. 2, when the media clock and video are consistent with each other in a title, including in an application designed to output a specific video image via a specific button, the specific video image is normally output, whereas when the media clock and video are inconsistent with each other, the specific button is output over an undesired video image. Therefore, the system time clock 140 cannot guarantee synchronization between the media clock used by an application of the advanced HD-DVD and the AV playback time.

### SUMMARY OF THE INVENTION

Aspects of the present invention provide a method and apparatus for generating a media clock used to calculate an adjusted playback time in order to reproduce audio/video (AV) content and operate an interactive application, and a recording medium storing the method.

According to an aspect of the present invention, there is provided a method of generating a media clock, the method comprising: confirming a presentation start time of an enhanced video object unit (EVOBU) corresponding to a system time clock (STC) of playback video; setting a media clock start time as an accumulated playback time of at least one EVOBU preceding the EVOBU corresponding to the STC; and setting the media clock of the playback video by adding the media clock start time to a difference value obtained by subtracting the presentation start time from the STC.

The setting of the media clock start time may comprise calculating the accumulated playback time by referring to a time map (TMAP) storing playback time information of the EVOBU.

The setting of the media clock start time may comprise converting the accumulated playback time expressed according to the number of frames into units of seconds by dividing the accumulated playback time by a frame frequency rate of an image display device that displays the EVOBU.

The setting of the media clock of the playback video may comprise converting the difference value obtained by subtracting the presentation start time from the STC into units of seconds by dividing the difference value by a unit of a presentation time stamp (PTS).

According to another aspect of the present invention, there is provided an apparatus for generating a media clock, the apparatus comprising: an EVOBU analyzing unit which confirms a presentation start time of an EVOBU corresponding to an STC of playback video; and a media clock calculating unit which sets a media clock start time as an accumulated playback time of at least one EVOBU preceding the EVOBU corresponding to the STC, and sets the media clock of the playback video by adding the media clock start time to a value obtained by subtracting the presentation start time from the STC.

The apparatus may further comprise: a TMAP analyzing unit which includes a TMAP which stores playback time information of an EVOBU, wherein the media clock calculating unit calculates the accumulated playback time by referring to the TMAP included in the TMAP analyzing unit.

The media clock calculating unit may convert an accumulated playback time expressed according as a number in units of frames into a number in units of seconds by dividing the accumulated playback time by a frame frequency rate of an output image display device that displays the EVOBU.

The media clock calculating unit may convert the difference value obtained by subtracting the presentation start time from the STC into a number in units of seconds by dividing the difference value by a time reference value of a unit of a PTS.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional playback apparatus;

FIG. 2 illustrates a problem in the playback apparatus of FIG. 1;

FIG. 3 is a block diagram of an advanced High-Definition Digital Versatile Disc (HD-DVD);

FIG. 4 is a flowchart illustrating a method of generating a media clock according to an embodiment of the present invention;

FIGS. 5A, 5B, and 5C illustrate information of a system clock and an enhanced video object unit (EVOBU) according to an embodiment of the present invention;

FIG. 6 is a diagram of an EVOBU used to explain a method of generating a media clock according to an embodiment of the present invention; and

FIG. 7 is a block diagram of an apparatus for generating a media clock according to an embodiment of the present invention.

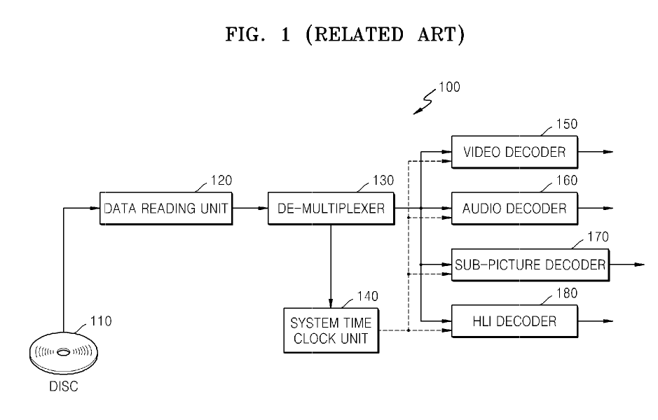

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A media clock indicates a time referred to by an application, which is a reference time used during operation of the application so as to synchronize video and the application.

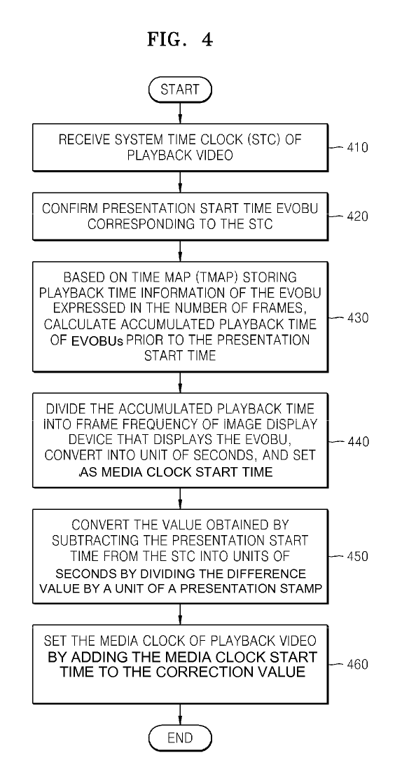

FIG. 4 is a flowchart illustrating a method of generating a media clock according to an embodiment of the present invention. Referring to FIG. 4, a system time clock (STC) of video that is to be reproduced is received (operation 410). The STC, which is a reference time of a moving picture experts group (MPEG) transmission system, is used to synchronize and reproduce video and audio at a proper time. If the output of video is not based on the STC, the output of video is based on a video presentation time stamp (PTS). The PTS refers to a time when video data is reconstructed and is substantially displayed on a screen since the STC and the video PTS are identical to each other.

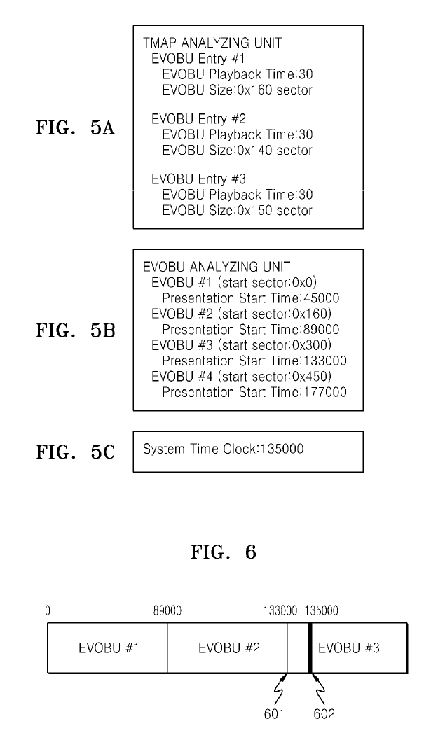

FIGS. 5A, 5B, and 5C illustrate information in a TMAP analyzing unit, EVOBU analyzing unit, and a system time clock, according to an embodiment of the present invention. Referring to FIG. 5C, the STC of video content currently being reproduced is 135000. If a media clock of the stream in FIG. 5C is calculated by only referring to the STC, the media clock can be obtained by dividing the STC of video content currently being reproduced, which is 135000, by a reference interval of a PTS designated as 90 kHz. The media clock is 1.5 seconds. If an output frequency rate of an image display device is 60 frames per second, the media clock, as expressed in minutes and seconds, is “00:00:01:30”.

A presentation start time and a start sector of an EVOBU corresponding to the STC are confirmed (operation 420). A group of pictures (GOP) is a set of pictures headed by ‘I picture’ in which the presentation start time is within 0.4˜1 second. The GOP is partitioned in a unit of navigation about which navigation information is generated. The unit of navigation is the EVOBU, and a data section corresponding to a recorded title is an enhanced video object (EVOB). Referring to FIG. 5B, since the STC is 135000, the EVOBU corresponding to the STC is EVOBU #3. Therefore, the presentation start time of the EVOBU #3 “133000” and the start sector “0x300” are confirmed.

Based on a TMAP storing playback time information of the EVOBU, expressed as a number in units of frames, an accumulated playback time of EVOBUs preceding the EVOBU corresponding to the STC is calculated (operation 430). The TMAP contains information on the size and time of the EVOBU. Referring to FIG. 5A, the TMAP includes information of an entry number, a playback time, and size of the EVOBU. A playback time of a corresponding EVOBU is expressed as the number of video fields (frames) contained in the EVOBU based on an output mode of 60 Hz or 50 Hz. The accumulated playback time of EVOBUs #1 through #2 is 60 frames since the playback time of EVOBU #1 is 30 frames and the playback time of EVOBU #2 is 30 frames.

The accumulated playback time is divided by the frame frequency rate of the image display device such as a television that displays the EVOBU, is converted into units of seconds, and is set as a media clock start time (operation 440). The frame frequency rate refers to the number of screens (frames) expressed per a second. If the accumulated playback time is 60 frames and the frame frequency rate of the image display device is 60 frames, then the result 60/60=1 second is obtained. Therefore a media clock start time which is set to 1 second is a time referred to by an application when a first video picture of the EVOBU corresponding to the STC of 135000 is output.

A correction value is obtained by dividing a difference value, which is obtained by subtracting the presentation start time of the EVOBU corresponding to the STC from the STC, by a unit of the PTS, and is converted into units of seconds in order to obtain a playback time between the first video picture of the EVOBU corresponding to the STC and a current video picture, PTS 135000 (operation 450). The playback time of the EVOBU corresponding to the STC can be easily obtained by detecting the PTS. A playback time of a corresponding MPEG video can be obtained by calculating a difference between the PTS of the first video picture of the EVOBU corresponding to the STC and the current video picture of PTS 135000, and dividing the difference value by 90 kHz. The playback time is obtained by dividing the difference value, obtained by subtracting the presentation start time of the EVOBU corresponding to the STC from the STC by 90 kHz. Since the STC is 135000 and the presentation start time is 133000, the difference value obtained by subtracting the two values is 2000. 2000 is then divided by 90000, and a correction value of 0.022 is obtained, and is in units of seconds.

The media clock of video reproduced is calculated and set by adding the media clock start time to the correction value (operation 460). Since the media clock start time is 1 second and the correction value is 0.022 seconds, the media clock of the video is set as 1.022 seconds. However, since the media clock is expressed in ‘hh:mm:ss:ff’, 0.022 seconds needs to be converted into units of frames. Therefore, 0.022 seconds is 1 frame based on the frame frequency rate of 60. Accordingly, the media clock is set as ‘00:00:01:01’.

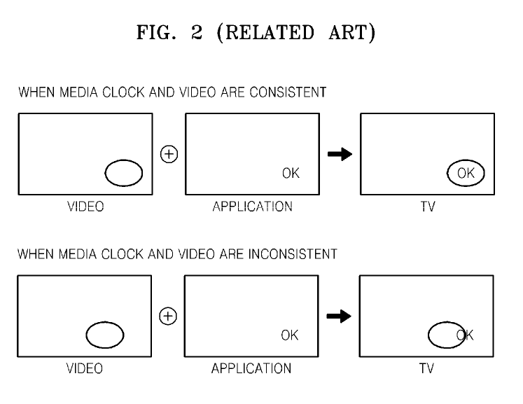

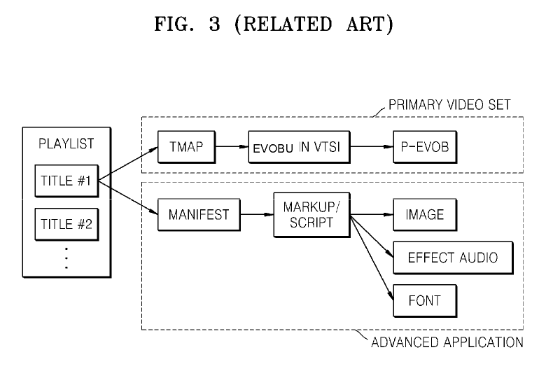

FIG. 6 is a diagram of an EVOBU used to explain the method of generating the media clock according to an embodiment of the present invention. Referring to FIG. 6, a reproducing STC is 135000 and is located at EVOBU #3. A playback time of EVOBU #1 is 30 frames and an end STC of EVOBU #1 is 89000. A playback time of EVOBU # is 30 frames, and an end STC of EVOBU #2 is 133000. Therefore, an accumulated playback time prior to EVOBU #3 is 60 frames, that is 1 second, and the presentation start time is 133000 (601). The STC of reproducing video is 135000 so that a difference value obtained by subtracting the two values is 2000. If the difference value of 2000 is divided by 90 kHz, a correction value of 0.022 seconds is obtained, which is converted into 1 frame. The media clock is ‘00:00:01:01’ according to a media clock expression method. The time ‘00:00:01:01’ that is calculated according to the media clock calculation method of an aspect of the present invention and the time ‘00:00:01:30’ that is calculated by referring to the conventional STC are completely different from each other. As shown in FIG. 2, the advanced application requiring synchronization with video pictures fails in terms of synchronization and erroneously operates under conventional operation. When the advanced application executed with the information shown in FIGS. 5A, 5B, and 5C is designed to display a specific image on a screen at the application media clock time ‘00:00:01:30’, the specific image is displayed on a current video picture corresponding to the STC 135000 according to the conventional art, whereas the STC 135000 is the media clock time ‘00:00:01:01’ according to an aspect of the present invention, so that the specific image is not displayed by the execution of the advanced application. It is incorrect when the specific image is displayed at the STC 135000 by the advanced application, as is done by the conventional art by referring to a playback time of each EVOBU. In more detail, it is correct when an image is output at the media clock time ‘00:00:01:01’ simultaneously with the output of the first video picture included in EVOBU #4 after the playback of EVOBU #3. Therefore, the advanced application can precisely use the media clock according to the media clock calculation method of an aspect of the present invention, thereby synchronizing a video picture and an advanced application.

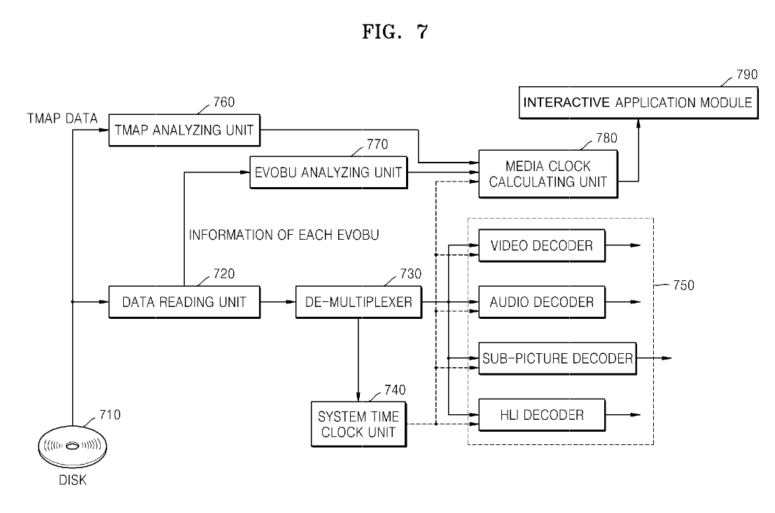

FIG. 7 is a block diagram of an apparatus for generating a media clock according to an embodiment of the present invention. Referring to FIG. 7, the apparatus for generating the media clock of the present embodiment comprises a disc 710, a data reading unit 720, a de-multiplexer 730, an STC unit 740, decoders 750, a TMAP analyzing unit 760, an EVOBU analyzing unit 770, a media clock calculating unit 780, and an interactive application module 790.

The disc 710, the data reading unit 720, the de-multiplexer 730, the STC unit 740, and the decoders 750 are similar to those of the conventional art and thus their descriptions will not be given here. However, if the STC unit 740 is not based on an STC to output video, the STC unit 740 is based on a PTS. The PTS refers to a time when video data is reconstructed and is displayed on the screen since the STC and the video PTS are identical to each other.

The TMAP analyzing unit 760 includes a TMAP which stores playback time information of at least one EVOBU. The TMAP includes information on an entry number, a playback time, and the size of the EVOBU. The playback time is a playback time of a corresponding EVOBU and is expressed as the number of video fields (frames) based on an output mode of 60 Hz or 50 Hz.

The EVOBU analyzing unit 770 determines a presentation start time from an enhanced video object unit corresponding to the STC of playback video.

The media clock calculating unit 780 sets a media clock start time an accumulated playback time of the at least one EVOBU preceding an EVOBU corresponding to the STC of the playback video, and sets the media clock of the playback video by adding the media clock start time to a value obtained by subtracting the presentation start time from the STC.

In more detail, the media clock calculating unit 780 calculates the presentation start time, i.e., an accumulated playback time of the at least one EVOBU preceding the EVOBU corresponding to the STC of the playback video by referring to the TMAP storing the playback time information of the EVOBU expressed according to the number of frames. The media clock calculating unit 780 divides the accumulated playback time by a frame frequency rate of an image display device such as a television set that displays the EVOBU, converts the divided accumulated playback time into units of seconds, and sets the converted accumulated playback time as the media clock start time. The frame frequency rate refers to the number of frames expressed in units of seconds. The media clock calculating unit 780 converts a correction value obtained by dividing a difference value which is obtained by subtracting the presentation start time from the STC by a unit of the PTS in units of seconds. A video playback time is obtained by dividing the difference value by 90 kHz. The media clock calculating unit 780 adds the media clock start time to the difference value converted into units of seconds, and converts the media clock start time into units of frames since the media clock needs to be expressed as ‘hh:mm:ss:ff’.

Aspects of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed network coupled computer systems so that the computer readable code is stored and executed in a distributed fashion. Also, functional programs, code and code segments for accomplishing aspects of the present invention can be easily construed by programmer of ordinary skill in the art to which the present invention pertains.

Aspects of the present invention calculate a media clock corresponding to each playback video displayed and uses the media clock as a reference time used during operation of an application, thereby synchronizing between the playback video and the application.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of generating a media clock, the method comprising:
confirming a presentation start time of an enhanced video object unit (EVOBU) corresponding to a system time clock (STC) of playback video;
setting a media clock start time as an accumulated playback time of at least one EVOBU preceding the EVOBU corresponding to the STC; and
setting the media clock of the playback video by adding the media clock start time to a difference value obtained by subtracting the presentation start time from the STC.

2. The method of claim 1, wherein the setting of the media clock start time comprises calculating the accumulated playback time by referring to one or more time maps (TMAPs) storing playback time information of the at least one EVOBU preceding the EVOBU corresponding to the STC.

3. The method of claim 2, wherein the setting of the media clock start time comprises converting the accumulated playback time expressed according to a number in units of frames into a number in units of seconds by dividing the accumulated playback time by a frame frequency rate of an image display device that displays the EVOBU corresponding to the STC.

4. The method of claim 3, wherein the setting of the media clock of the playback video comprises converting the difference value obtained by subtracting the presentation start time from the STC into units of seconds by dividing the difference value by a unit of a presentation time stamp (PTS).

5. A computer readable recording medium storing a program for executing the method of generating a media clock, the method comprising:
confirming a presentation start time of an enhanced video object unit (EVOBU) corresponding to a system time clock (STC) of playback video;
setting a media clock start time as an accumulated playback time of at least one EVOBU preceding the EVOBU corresponding to the STC; and
setting the media clock of the playback video by adding the media clock start time to a difference value obtained by subtracting the presentation start time from the STC.

6. An apparatus for generating a media clock, the apparatus comprising:
an enhanced video object unit (EVOBU) analyzing unit which confirms a presentation start time of an EVOBU corresponding to a system time clock (STC) of playback video; and
a media clock calculating unit which sets a media clock start time as an accumulated playback time of at least one EVOBU preceding the EVOBU corresponding to the STC, and sets the media clock of the playback video by adding the media clock start time to a value obtained by subtracting the presentation start time from the STC.

7. The apparatus of claim 6, further comprising:
a TMAP analyzing unit which includes a TMAP storing playback time information of the EVOBU,
wherein the playback time information includes an entry number, a playback time and a size of the EVOBU, and
wherein the media clock calculating unit calculates the accumulated playback time by referring to the TMAP.

8. The apparatus of claim 7, wherein the media clock calculating unit converts the accumulated playback time expressed according to a number in units of frames into a number in units of seconds by dividing the accumulated playback time by a frame frequency rate of an image display device that displays the EVOBU.

9. The apparatus of claim 8, wherein the media clock calculating unit converts a difference value obtained by subtracting the presentation start time from the STC into units of seconds by dividing the difference value by a unit of a presentation time stamp (PTS).

10. The apparatus of claim 6, further comprising an STC unit generating the STC based on a PTS if the STC unit is not based on an STC of output video.

11. A method of displaying an enhanced video object unit (EVOBU) comprising:
displaying an EVOBU corresponding to a system time clock (STC) in synchronization with displaying a playback video on an image display device by generating a media clock to play the playback video in synchronization with the EVOBU corresponding to the STC.

12. The method of claim 11, further comprising:
confirming a presentation start time of the EVOBU corresponding to the STC;
setting a media clock start time as an accumulated playback time of at least one EVOBU preceding the EVOBU corresponding to the STC; and
setting a media clock of the playback video by adding the media clock start time to a difference value obtained by subtracting the presentation start time from the STC.

13. The method of claim 12, wherein the setting of the media clock start time comprises calculating the accumulated playback time by referring to one or more time maps (TMAPs) storing playback time information of the at least one EVOBU preceding the EVOBU corresponding to the STC.

14. The method of claim 12, wherein the setting of the media clock start time comprises converting the accumulated playback time expressed according to a number in units of frames into a number in units of seconds by dividing the accumulated playback time by a frame frequency rate of an image display device that displays the EVOBU corresponding to the STC.

15. The method of claim 12, wherein the setting of the media clock of the playback video comprises converting the difference value obtained by subtracting the presentation start time from the STC into units of seconds by dividing the difference value by a unit of a presentation time stamp (PTS).

16. A computer readable recording medium storing a program for executing the method of displaying an enhanced video object unit (EVOBU) comprising:
displaying an EVOBU corresponding to a system time clock (STC) in synchronization with displaying a playback video on an image display device by generating a media clock to play the playback video in synchronization with the EVOBU corresponding to the STC.

17. An apparatus for displaying an enhanced video object unit (EVOBU), the apparatus comprising:
an EVOBU analyzing unit confirming a presentation start time of an EVOBU corresponding to a system time clock (STC) of a playback video to display the EVOBU and playback video; and
a media clock calculating unit generating a media clock to display a playback video in synchronization with an EVOBU corresponding to the STC.

18. The apparatus of claim 17, further comprising:
a time map (TMAP) analyzing unit which includes a TMAP storing playback time information of the EVOBU, and
wherein the playback time information includes an entry number, a playback time and a size of the EVOBU.

19. The apparatus of claim 18, wherein the media clock calculating unit calculates an accumulated playback time by referring to one or more TMAPs storing playback time information of the at least one EVOBU preceding the EVOBU corresponding to the STC.

20. The apparatus of claim 19, wherein the media clock calculating unit sets a media clock start time as the accumulated playback time of at least one EVOBU preceding the EVOBU corresponding to the STC.

21. The apparatus of claim 20, wherein the media clock calculating unit sets the media clock of the playback video by adding the media clock start time to a difference value obtained by subtracting the presentation start time from the STC.

22. The apparatus of claim 19, wherein the media clock calculating unit converts the accumulated playback time expressed according to a number in units of frames into a number in units of seconds by dividing the accumulated playback time by a frame frequency rate of an image display device that displays the EVOBU.

23. The apparatus of claim 21, wherein the media clock calculating unit converts the difference value obtained by subtracting the presentation start time from the STC into units of seconds by dividing the difference value by a unit of a presentation time stamp (PTS).

24. The apparatus of claim 17, further comprising an STC unit generating the STC based on a PTS if the STC unit is not based on an STC of output video.
